(19) United States
(12) Patent Application Publication
(10) Pub. No.: US 2016/0298001 A1
(43) Pub. Date: Oct. 13, 2016

(54) ADHESIVE TAPE

(71) Applicant: Tecman Speciality Materials Ltd, Warwickshire (GB)

(72) Inventor: Kevin Porter, Warwickshire (GB)

(21) Appl. No.: 14/789,023

(22) Filed: Jul. 1, 2015

(30) Foreign Application Priority Data
Apr. 13, 2015 (GB) 1506261.5
Apr. 15, 2015 (GB) 1506413.2

(51) Int. Cl. C09J 7/04; B29C 65/50

(52) U.S. Cl. CPC C09J 7/045; B29C 65/5021; B29C 65/5057; B29L 2031/30

(57) ABSTRACT

An adhesive tape having a perforated carrier carrying on opposite sides a structural adhesive with tack such that two articles can be connected by the adhesive tape. The two articles are initially held together by pressure. A direct bond from one article to the other through the perforations in the carrier is subsequently formed to secure the two articles together.

### FEDERALLY SPONSORED RESEARCH OR DEVELOPMENT

Not Applicable.

### CROSS-REFERENCE TO RELATED APPLICATIONS

This application claims priority in Great Britain Appln. No. 1506261.5, filed Apr. 13, 2015 and Great Britain Appln. No. 1506413.2, filed Apr. 15, 2015, both of which are entitled “Adhesive Tape”. The full disclosures of these applications are hereby incorporated by reference.

### MICROFICHE/COPYRIGHT REFERENCE

Not Applicable.

### FIELD OF THE INVENTION

The invention relates to an adhesive tape.

### BACKGROUND OF THE INVENTION

It is known to use double-sided adhesive tapes to connect two or more articles. The applications for which such double-sided adhesive tapes can be used are limited by both the strength of the connection to hold the articles together during assembly (the initial adhesion strength) and the strength of the connection to hold the articles together during use (the final adhesion strength).

Known adhesive tapes are not suitable for structural bonding applications, for example automotive, aerospace or constructions applications, which require significant initial and final adhesion strengths along with a cohesive strength equivalent to liquid adhesives such as epoxy and polyurethane (PU).

### SUMMARY OF THE INVENTION

According to a first aspect of the present invention there is provided an adhesive tape comprising a perforated carrier carrying on opposite sides a structural adhesive with tack such that two articles can be connected by the adhesive tape, the two articles being initially held together by pressure and subsequently bonded by the structural adhesive so that the structural adhesive forms a direct bond from one article to the other through the perforations in the carrier.

The structural adhesive with tack advantageously ensures that the initial adhesion strength of the adhesive is sufficient to hold the two articles in position during assembly, prior to formation of the structural bond between the two articles. This facilitates transportation of articles during manufacture, for example along a manufacturing line. The present invention is also advantageous as the formation of a direct bond from one article to the other through the perforations in the carrier enables a high final adhesion and cohesion strength to be achieved through a homogenous reinforced bond line.

Providing the adhesive in tape form advantageously provides a uniform bond thickness, as the risk of the adhesive running or slumping prior to final assembly of components is eliminated.

The perforated carrier may be woven and/or may comprise a plurality of reinforcement fibres, for example, reinforcement fibres including glass. The reinforcement fibres further increase the strength of the bond or connection between the two articles, and advantageously provides impact resistance.

The structural adhesive may be cross-linkable and the bond between the two articles may be a cross-linked bond. The cross-linked bond further increases the final adhesion strength.

The structural adhesive may comprise a polymer, for example, a thermosetting polymer. The polymer may comprise a polyepoxide, for example, polyepoxyacrylate.

The structural adhesive may include a tackifier. Molecules of a tackifier may be distributed throughout the structural adhesive. Alternatively, the structural adhesive may be inherently tacky. The tackifier increases the initial adhesion strength.

The structural adhesive may comprise a release layer on one side, for example a release layer having a silicone coating. The release layer advantageously enables the adhesive tape to be rolled up for storage and/or transportation.

According to a second aspect of the present invention there is provided a structure comprising two articles connected by an adhesive tape according to the first aspect of the present invention.

According to a third aspect of the present invention there is provided a vehicle comprising two panels connected by an adhesive tape according to the first aspect of the present invention.

According to a fourth aspect of the present invention there is provided a method of connecting two articles comprising the steps a) providing an adhesive tape comprising a perforated carrier carrying a structural adhesive with tack on opposite sides; b) placing adhesive tape between the two articles and applying pressure to hold two articles in a desired position; c) activating the adhesive so that a direct bond is formed from one article to the other through the perforations in the carrier.

The structural adhesive may comprise a polymer, and the step of activating the adhesive so that a direct bond is formed from one article to the other may include curing the polymer.

According to a further aspect of the invention there is provided a method of forming a structure using the method of connecting two articles according to the fourth aspect of the present invention.

Other objects, features, and advantages of the invention will become apparent from a review of the entire specification, including the appended claims and drawings.

### BRIEF DESCRIPTION OF THE DRAWINGS

An embodiment of the invention will now be described by way of example and with reference to the accompanying drawings, in which:

FIG. 1 is a perspective view of an adhesive tape according to a first embodiment of the present invention;

FIG. 2 is a side view of a structure comprising two articles connected by the adhesive tape of FIG. 1;

FIG. 3 is a plan view of a perforated carrier for use in the adhesive tape of FIG. 1;

FIG. 4 is a side view of the adhesive tape of FIG. 1 being applied to an article;

FIG. 5 is a side view of the structure of FIG. 2 during assembly; and

FIG. 6 is an alternative side view of the structure of FIG. 2 during assembly.

### DETAILED DESCRIPTION OF THE PREFERRED EMBODIMENT

Referring now to FIG. 1 there is shown a piece of adhesive tape 10 according to the present invention. The adhesive tape 10 has a perforated carrier 20, a first adhesive layer 22 and a second adhesive layer 24. As shown in FIG. 1, the adhesive tape 10 also has a protective release layer 26.

The carrier 20 is a scrim carrier and has a pair of opposing surfaces 28a, 28b and a mesh of interconnected fibres 30 that are separated by a plurality of perforations 32, as shown in FIG. 3. The carrier 20 is in the form of a tape or ribbon. The fibres 30 are glass fibres.

The first adhesive layer 22 is a polymeric adhesive 34 with inherent tack properties, for example a thermosetting rubber or polyepoxyacrylate. The first adhesive layer has a pair of opposing surfaces 38a, 38b.

The second adhesive layer 22 is also a polymeric adhesive 34 with inherent tack properties, for example a thermosetting rubber or polyepoxyacrylate. The second adhesive layer has a pair of opposing surfaces 40a, 40b.

The release layer 26 has a pair of opposing surfaces 42a, 42b. Surface 42a and 42b of the release layer 26 each have a silicone coating (not shown).

The adhesive tape 10 is prepared as follows.

The first adhesive layer 22 is applied to the carrier 20 such that surface 28a of the carrier 20 is in contact with and adhered to surface 38b of the first adhesive layer 22.

The second adhesive layer 24 is applied to the carrier 20 such that surface 28b of the carrier 20 is in contact with and adhered to surface 40a of the second adhesive layer 24.

A release layer 26 is applied to the first adhesive layer 22 such that surface 42b of the release layer 26 is in releasable contact with surface 38a of the first adhesive layer 22.

The adhesive tape 10 is wound into rolls up to 1600 mm wide and up to 1000 m in length and processed into smaller rolls using known slit/rewind or rewind/slit equipment for transportation and/or storage and/or application.

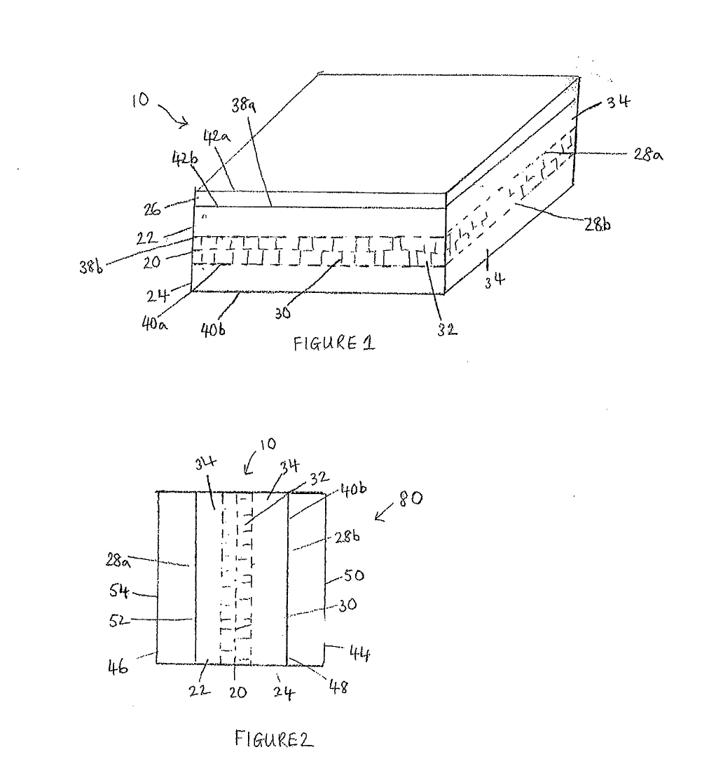

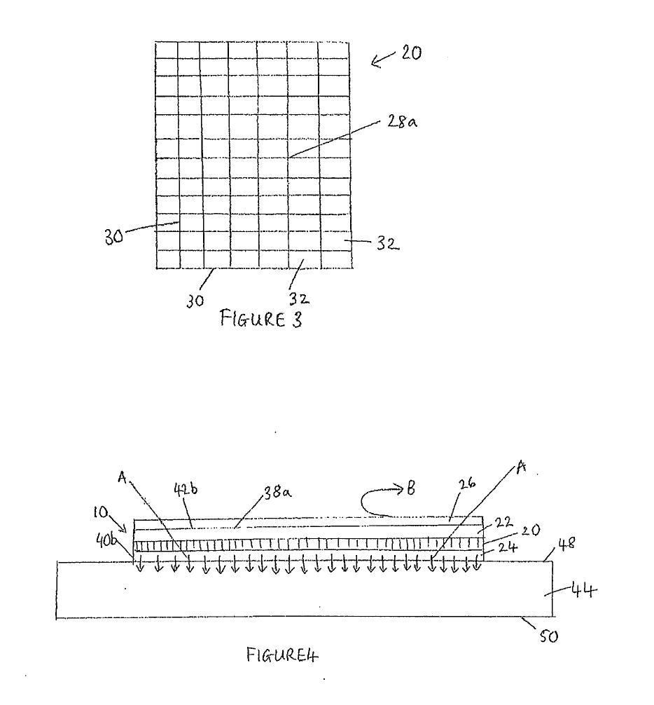

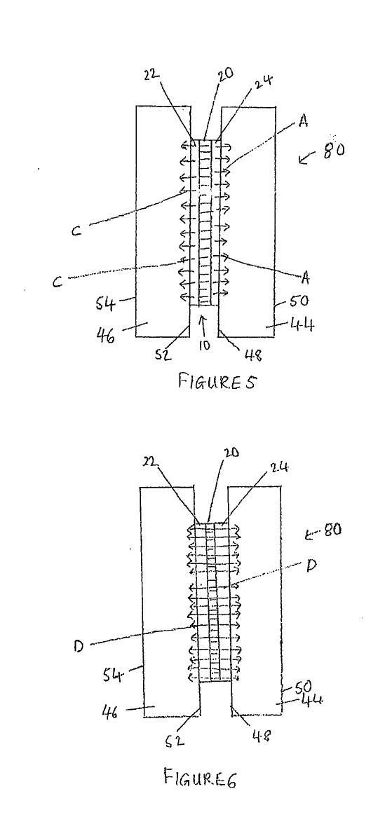

Use of the adhesive tape 10 to form a structure 80 by connecting two carbon-fibre composite articles 44, 46 will now be described with reference to FIGS. 4 to 6.

The first carbon-fibre composite article 44 has an inner surface 48 and an outer surface 50.

The second carbon-fibre composite article 46 has an inner surface 52 and an outer surface 54.

The adhesive tape 10 is applied to the first article 44 such that surface 40b of the second adhesive layer 24 is in contact with the inner surface 48 of the first article 44. The tackiness (shown by arrows A) of the second adhesive layer 24 adheres the adhesive tape 10 to the first article 44.

The protective release layer 26 is removed from the first adhesive layer 22 by peeling surface 42b of the release layer 26 away from surface 38a of the first adhesive layer 22 in the direction of arrow B.

The second article 46 is positioned in a desired position relative to the first article 44 and pressed into contact with the adhesive tape 10. The inner surface 52 of the second article 46 is pressed into contact with surface 38a of the first adhesive layer 22. The tackiness (shown by arrows C) of the first adhesive layer 22 adheres the adhesive tape 10 to the second article 46.

In this way the first and second articles 44, 46 are held in the desired position to form structure 80. The tack properties of the first and second adhesive layers 22, 24 advantageously provides the initial adhesion strength required to retain the first and second articles 44, 46 in the desired position.

Once the first and second articles 44, 46 are in the desired position, an activator, for example heat or ultra violet radiation, is applied to the structure 80.

The activator causes the formation of cross-links (depicted by arrows D) in the polymeric adhesive 34 of both the first and second adhesive layers 22, 24. The cross-links are formed through the perforations 32 in the carrier 20 to the first and second articles 44, 46 to provide a homogenous bond line.

In this way a structural bond is formed between the first and second articles 44, 46 of the structure 80. The formation of the cross-linked bond through the perforations 32 in the carrier 20 provides the high final adhesion strength required for high performance applications. The carrier 20 acts as a reinforcement within the bond, providing additional strength. The final adhesion strength of the adhesive tape 10 is 6 to 12 KN/25 mm2.

The first and second articles 44, 46 may be panels for a vehicle, for example a car. The adhesive tape 10 may be up to 25 mm in width and used in lengths up to 10 m, for example having 0.05 mm-0.1 mm thick carrier and 0.05 mm-0.1 mm adhesive on each side.

In the example described above, the first and second adhesive layers comprise a polymeric adhesive with inherent tack properties. In alternative embodiments, the first and second adhesive layers may be formed from a polymer matrix in which molecules of a tackifier, a chemical compound that increases the tack or stickiness of the surface of an adhesive, are dispersed.

In the example described above, the carrier is formed from a mesh of interconnected fibres that are separated by a plurality of perforations. In alternative embodiments, the carrier may be formed from any woven or knitted structure in which the fibres are separated by perforations or openings.

In the example described above, the first and second articles are carbon-fibre composite articles. In alternative embodiments, the first and/or second article may be manufactured from any material.

1. An adhesive tape comprising a perforated carrier and a structural adhesive with tack, the carrier having two opposite sides and carrying on said opposite sides the structural adhesive with tack such that two articles can be connected by the adhesive tape, the two articles being initially held together by pressure and subsequently bonded by the structural adhesive so that the structural adhesive forms a direct bond from one article to the other through the perforations in the carrier.

2. An adhesive tape according to claim 1, wherein the perforated carrier is woven.

3. An adhesive tape according to claim 1, wherein the perforated carrier comprises a plurality of reinforcement fibres.

4. An adhesive tape according to claim 2, wherein the perforated carrier comprises a plurality of reinforcement fibres.

5. An adhesive tape according to claim 3, wherein the reinforcement fibres comprise glass.

6. An adhesive tape according to claim 4, wherein the reinforcement fibres comprise glass.

7. An adhesive tape according to claim 1, wherein the structural adhesive is cross-linkable and the bond between the two articles is a cross-linked bond.

8. An adhesive tape according to claim 1, wherein the structural adhesive comprises a polymer.

9. An adhesive tape according to claim 8, wherein the polymer comprises a thermosetting polymer.

10. An adhesive tape according to claim 8, wherein the polymer comprises a polyepoxide.

11. An adhesive tape according to claim 8, wherein the polymer comprises polyepoxyacrylate.

12. An adhesive tape according to claim 1, wherein the structural adhesive includes a tackifier.

13. An adhesive tape according to claim 12, wherein molecules of the tackifier are distributed throughout the structural adhesive.

14. An adhesive tape comprising a perforated carrier and a structural adhesive with tack, the carrier being woven and having two opposite sides, the carrier carrying on the opposite sides the structural adhesive with tack such that two articles can be connected by the adhesive tape, the structural adhesive being a cross-linkable polymer, the two articles being initially held together by pressure and subsequently bonded by the structural adhesive so that the structural adhesive forms a direct, cross-linked bond from one article to the other through the perforations in the carrier.

15. An adhesive tape according to claim 14, wherein the polymer comprises a polyepoxide.

16. An adhesive tape according to claim 14, wherein the polymer comprises polyepoxyacrylate.

17. An adhesive tape according to claim 14, wherein the structural adhesive includes a tackifier, and the molecules of the tackifier are distributed throughout the structural adhesive.

18. A structure comprising two articles connected by an adhesive tape according to claim 1.

19. A vehicle comprising two panels connected by an adhesive tape according to claim 1.

20. A method of connecting two articles comprising the steps:
a) providing an adhesive tape comprising a perforated carrier carrying a structural adhesive with tack on opposite sides;
b) placing the adhesive tape between the two articles and applying pressure to hold the two articles in a desired position;
c) activating the adhesive so that a direct bond is formed from one article to the other through the perforations in the carrier.

21. A method of connecting two articles according to claim 20, wherein the structural adhesive comprises a polymer and the step of activating the structural adhesive so that a direct bond is formed from one article to the other includes curing the polymer.
